(19) United States
(12) Patent Application Publication
(10) Pub. No.: US 2018/0167886 A1
(43) Pub. Date: Jun. 14, 2018

(54) INTERNET OF THINGS SYSTEM HAVING STANDBY COMMUNICATION PROTOCOL

(71) Applicant: PORTWELL INC., NEW TAIPEI CITY (TW)

(72) Inventor: KUAN-YU CHOU, NEW TAIPEI CITY (TW)

(21) Appl. No.: 15/596,573

(22) Filed: May 16, 2017

(30) Foreign Application Priority Data
Dec. 9, 2016 (TW) 105140818

(51) Int. Cl. H04W 52/02; H04W 24/08

(52) U.S. Cl. CPC H04W 52/0241; H04W 24/08

(57) ABSTRACT

An IoT (Internet of Things) system includes at least one IoT control end and at least one IoT device. The IoT control end includes at least one wireless primary communication protocol and at least one wireless standby communication protocol. The IoT device includes at least one wireless primary communication protocol corresponding to the IoT control end and at least one wireless standby communication protocol supporting the IoT device. The wireless standby communication protocol supporting the IoT device is disposed at the IoT control end. Wherein, when in a normal communication state, the IoT control end communicates with the IoT device via the wireless primary communication protocol. When communication between the IoT control end and the IoT device is interrupted, the communication between the IoT control end and the IoT device is switched to the wireless standby communication protocol supporting the IoT device.

### FIELD OF THE INVENTION

The present invention relates to an IoT (Internet of Things) system, and more particularly to an IoT system having a standby communication protocol. When in a normal state, communication of the IoT is operated via a wireless primary communication protocol. When in an abnormal state, communication of the IoT is switched to a wireless standby communication protocol. The IoT system has better application and economy and security.

### BACKGROUND OF THE INVENTION

The Internet of things (IoT) is the inter-networking of physical devices which are embedded with electronics, software, sensors, actuators, and network connectivity that enable these objects to collect and exchange data. In recent years, the IoT and IoT devices are developed quickly, such as in the field of smart grid, utility companies can optimize electricity to the home and store; in the field of home and building automation, a smart home and building can have centralized control of any device in the home or office; in the field of asset tracking, businesses, hospitals, and factories can accurately track the location of high-value equipment, patients, vehicles, and so on. As the application of Internet of Things is quite extensive, it will become an important trend for the integration and application of science and technology in the future.

FIG. 1 is a schematic view of a conventional IoT system, which includes an IoT control end 80 and a plurality of IoT devices 90. The IoT control end 80 includes a first wireless communication protocol 81, a second wireless communication protocol 82 . . . , and an nth communication protocol 8n. The plurality of IoT devices 90 includes a first IoT device 91, a second IoT device 92 . . . , and an nth IoT device 9n, which are provided with a first wireless communication protocol 81, a second wireless communication protocol 82 . . . , and an nth wireless communication protocol 8n, respectively. The first wireless communication protocol 82 is wirelessly communicated with the first IoT device 91. The second wireless communication protocol 82 is wirelessly communicated with the second IoT device 92. The nth wireless communication protocol 8n is wirelessly communicated with the nth IoT device 9n. The first wireless communication protocol 81, the second wireless communication protocol 82 . . . , and the nth wireless communication protocol 8n may be TCP/IP, Bluetooth, Zigbee, Wi-Fi Z-Wave or sigfox.

Although the aforesaid IoT system can achieve the purpose of an application of the IoT, but the communication stability between the IoT control end 80 and the plurality of IoT devices 90 will be considered. Because of the limitations of wireless communication technology, strong communication signals of the mobile phones as an application of the IoT will consume power too much. As to the current short-range communication technology (81-8n), the communication is instable and the capability of penetrating wall is not good. This will limit the application and development of Internet of things greatly. When the communication is unstable or interrupted, the IoT control end 80 and the plurality of IoT devices 90 cannot transmit control instructions, resulting in a failure of the IoT. For example, in case the first wireless communication protocol 81 is a security alert/notification system, if the first wireless communication protocol 81 of the IoT control end 80 or the first wireless communication protocol 91 of the first IoT device 90 malfunctions, the IoT control end 80 and the first IoT device 90 cannot communicate with each other. That is, the first IoT device 90 cannot get the instruction of the IoT control end 80 to operate, resulting in a failure of the security warning/notification system. The design of the IoT is not ideal. Accordingly, the inventor of the present invention has devoted himself based on his many years of practical experiences to solve these problems.

### SUMMARY OF THE INVENTION

The primary object of the present invention is to provide an IoT (Internet of Things) system having a standby communication protocol which can achieve a better application and economy of the Internet of Things by the appropriate setting of a primary communication between an IoT control end and a plurality of IoT devices. Through the standby communication of the Internet of Things, when the communication is instable or interrupted, it can be automatically switched to the standby communication for continuous operation, so that the operation of the Internet of things can be kept smooth to achieve excellent convenience and security for the use of the Internet of things.

In order to achieve the aforesaid object, the IoT system of the present invention comprises at least one IoT control end and at least one IoT device. The IoT control end includes at least one wireless primary communication protocol and at least one wireless standby communication protocol. The IoT device includes at least one wireless primary communication protocol corresponding to the IoT control end and at least one wireless standby communication protocol supporting the IoT device. The wireless standby communication protocol supporting the IoT device is disposed at the IoT control end. Wherein, when in a normal communication state, the IoT control end communicates with the IoT device via the wireless primary communication protocol. When communication between the IoT control end and the IoT device is interrupted, the communication between the IoT control end and the IoT device is switched to the wireless standby communication protocol supporting the IoT device so that the IoT control end and the IoT device whose communication is interrupted can continue to communicate with each other normally.

Preferably, the IoT control end includes a switching module.

Preferably, the switching module is one of a microcontroller and a system on chip (SoC).

Preferably, the wireless primary communication protocol is a LoRa (Long Range) communication protocol.

Preferably, the wireless standby communication protocol is one of TCP/IP, Bluetooth, Zigbee, Wi-Fi 2G, 3G, 4G, RFID, NFC, Z-Wave, and sigfox.

Preferably, the IoT control end is one of a gateway, a router, a switch and a Wi-Fi router.

Preferably, the IoT control end is a mobile device which is one of a mobile phone, a laptop, a tablet, and a personal digital assistant, such that the IoT control end has the function of the mobile device.

Preferably, the IoT system further comprises an operation process. The operation process comprises the steps of:

step 1: the IoT control end communicating with the at least one IoT device through the wireless primary communication protocol thereof;

step 2: the switching module detecting whether communication between the IoT control end and the IoT device is normal or not; if yes, going to step 1 to execute operation of the IoT continuously; if no, going to step 3;

step 3: the switching module switching the wireless primary communication protocol of the IoT control end and the corresponding IoT device to the wireless standby communication protocol supporting the IoT device so that the IoT control end communicates with the IoT device through the wireless standby communication protocol; wherein the communication protocol of the corresponding IoT device is also switched to the wireless standby communication protocol thereof.

### BRIEF DESCRIPTION OF THE DRAWINGS

FIG. 1 is a schematic view of a conventional IoT system;

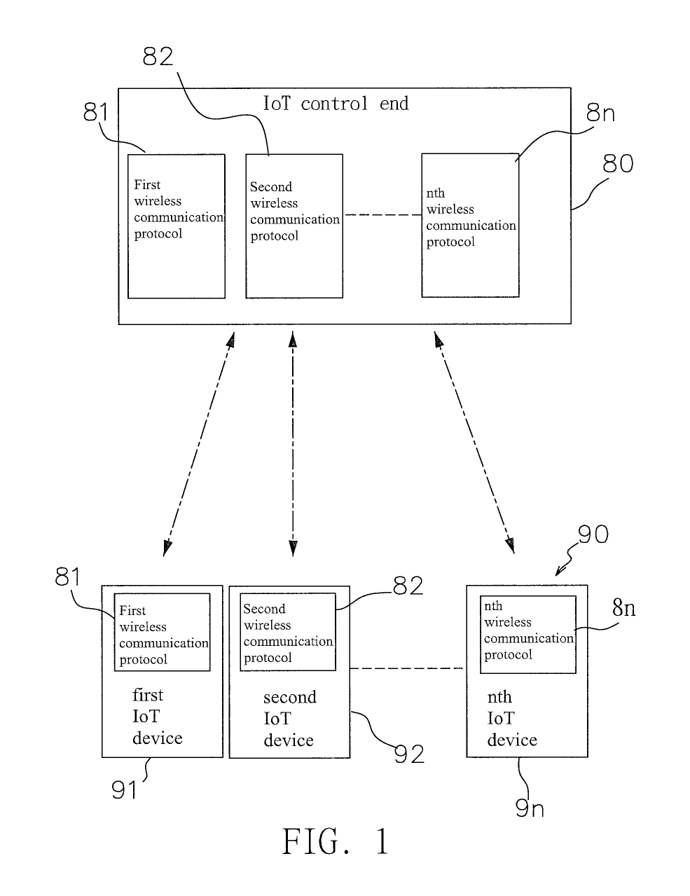

FIG. 2 is a schematic view of an IoT system of the present invention;

FIG. 3 is a flowchart of the operation of the present invention; and

FIG. 4 is a schematic view showing an application of the present invention.

### DETAILED DESCRIPTION OF THE PREFERRED EMBODIMENTS

Embodiments of the present invention will now be described, by way of example only, with reference to the accompanying drawings.

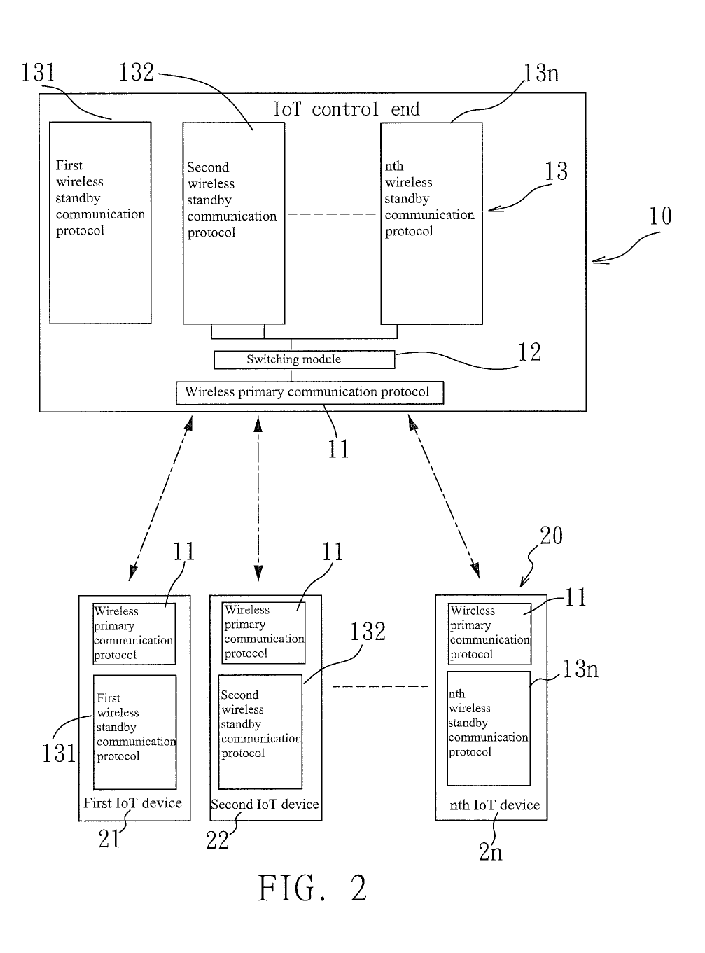

FIG. 2 is a schematic view of an IoT (Internet of Things) system having a standby communication protocol which is implemented in the IoT system of the present invention. The IoT system includes an IoT control end 10 and a plurality of IoT devices 20 which are communicated with each other via signals. The IoT control end 10 may be a gateway, a router, a switch or a Wi-Fi router. The IoT control end 10 may be a mobile device. The mobile device may be a mobile phone, a laptop, a tablet, or a personal digital assistant, so that the IoT control end 10 has the functions of the mobile device.

The IoT control end 10 includes a wireless primary communication protocol 11, a switching module 12, and a plurality of wireless standby communication protocols 13. The type of the wireless primary communication protocol 11 is not limited. In a preferred embodiment, the wireless primary communication protocol 11 is a LoRa (Long Range) communication protocol. The LoRa communication protocol can carry a long distance transmission of several kilometers, and its low frequency and high wavelength communication transmission has strong penetrability and stable characteristics. This is beneficial for the application and development of the IoT. The switching module 12 is capable of automatically switching between the wireless primary communication protocol 11 and the plurality of wireless standby communication protocols 13 immediately. The plurality of wireless standby communication protocols 13 include a first wireless standby communication protocol 131, a second wireless standby communication protocol 132 . . . , and an nth wireless standby communication protocol 13n.

The plurality of IoT devices 20 include a first IoT device 21, a second IoT device 22 . . . , and an nth IoT device 2n each provided with the wireless primary communication protocol 11. The wireless primary communication protocols 11 of the first IoT device 21, the second IoT device 22 . . . , and the nth IoT device 2n communicate with the wireless primary communication protocol 11 of the IoT control end 10, respectively.

Further, the first IoT device 21, the second IoT device 22 . . . , and the nth IoT device 2n include a first wireless standby communication protocol 131, a second wireless standby communication protocol 132 . . . , and an nth wireless standby communication protocol 13n, respectively. The first wireless standby communication protocol 131, the second wireless standby communication protocol 132 . . . , and the nth wireless standby communication protocol 13n of the first IoT device 21, the second IoT device 22 . . . , and the nth IoT device 2n communicate with the first wireless standby communication protocol 131, the second wireless standby communication protocol 132 . . . , and the nth wireless standby communication protocol 13n of the IoT control end 10, respectively. The wireless standby communication protocols (131-13n) may be TCP/IP, Bluetooth, Zigbee, Wi-Fi 2G, 3G, 4G, RFID, NFC, Z-Wave, sigfox, and the like. The Z-Wave communication protocol is a communication protocol presented by the Z-Wave Alliance, which has advantages in the field of home automation application and home digitization integration. The foregoing sigfox communication protocol is a communications protocol provided by the exclusive supplier SIGFOX of the Internet of Things (IoT), which has the features of remote and low-power connectivity.

In a normal communication state, the IoT control end 10 communicates with any one of the IoT devices 20 via the wireless primary communication protocols 11 thereof. When the wireless primary communication of the IoT control end 10 and the IoT device 20 is interrupted, the IoT control end 10 and the IoT device 20 whose communication is interrupted switch their communication protocols to the wireless standby communication protocols 13 thereof, such that the IoT control end 10 and the IoT device 20 whose communication is interrupted can continue to communicate with each other normally.

When the wireless primary communication of the IoT control end 10 and the IoT device 20 is interrupted, the switching module 12 of the IoT control end 10 switches its communication to the wireless standby communication protocol 13 supporting the IoT device 20 whose communication is interrupted, and the IoT device 20 whose communication is interrupted also switches its communication to the wireless standby communication protocol 13 via a built-in switching module (not shown), so that the IoT device 20 whose communication is interrupted can still communicate with the IoT control end 10.

The wireless primary communication protocol 11 of the IoT control end 10 may continue to transmit information to the wireless primary communication protocol 11 of the IoT device 20. When the switching module 12 detects that the wireless primary communication protocol 11 of any one of the IoT devices 20 is interrupted, for example, if there is no response within a set time exceeding the set times, the switching module 12 automatically switches the communication to the wireless standby communication protocol 13 supporting the IoT device 20 whose communication is interrupted for communicating with the wireless standby communication protocol 13 of the IoT device 20 whose communication is interrupted, so that the IoT device 20 whose communication is interrupted can still communicate with the IoT control end 10.

The switching module 12 may be a microcontroller or a system on chip (SoC).

The characteristic of the system is that the wireless network automatic switching system of the Internet of Things can automatically switch the communication to the standby communication protocol so as to maintain the network normally when the communication is interrupted according to a change of the unpredictable environment of the network. Besides, when the wireless primary communication protocol is the LoRa communication protocol, the power consumption of the IoT device can be saved, the distance of the communication signal is longer, and the capability of penetrating wall is also stronger.

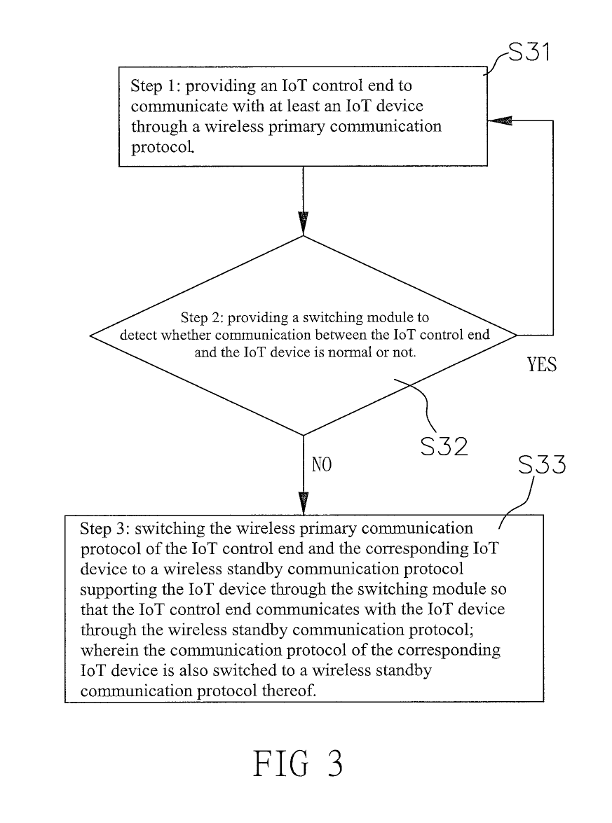

Please refer to FIG. 3, which is a schematic diagram of an operation process for an IoT (Internet of Things) system having a standby communication protocol of the present invention. The operation process comprises the steps of:

step 1 S31: providing an IoT control end to communicate with at least an IoT device through a wireless primary communication protocol;

step 2 S32: providing a switching module to detect whether communication between the IoT control end and the IoT device is normal or not;

if yes, going to step 1 S31 to execute the operation of the IoT continuously;

if no, going to step 3;

step 3 S33: switching the wireless primary communication protocol of the IoT control end and the corresponding IoT device to a wireless standby communication protocol supporting the IoT device through the switching module so that the IoT control end communicates with the IoT device through the wireless standby communication protocol; wherein the communication protocol of the corresponding IoT device is also switched to a wireless standby communication protocol thereof.

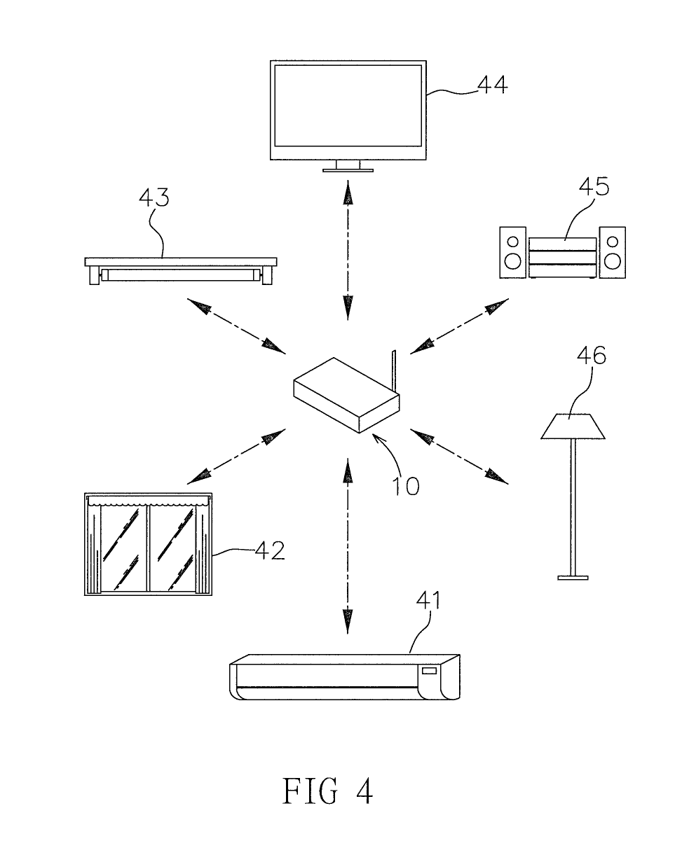

FIG. 4 is a schematic view showing an application of the IoT system having a standby communication protocol of the present invention. The IoT control end 10 communicates with the IoT devices 20, such as an air conditioner 41, a window 42, a fluorescent lamp 43, a television 44, an audio 45, and a table lamp 46 for interconnection of the Internet of Things. In a normal state, the IoT control end 10 uses the wireless primary communication protocol (e.g., LoRa communication protocol) to communicate with the air conditioner 41, the window 42, the fluorescent lamp 43, the television 44, the audio 45, and the table lamp 46, respectively. This way can save the power consumption of each IoT device. The distance of the communication signal is longer and the capability of penetrating wall is also stronger to enhance the application of the Internet of Things. When the communication between the IoT control end 10 and any one of the air conditioner 41, the window 42, the fluorescent lamp 43, the television 44, the audio 45, and the table lamp 46 is interrupted, it is automatically switched to the wireless standby communication protocol 13 supporting the IoT device whose communication is interrupted so as to maintain the normal operation of the network for maintaining the stability and quality of home life.

The IoT system having a standby communication protocol of the present invention can achieve a better application and economy of the Internet of Things by the appropriate setting of the primary communication between the IoT control end and the plurality of IoT devices. Through the standby communication of the Internet of Things, when the communication is instable or interrupted, it can be automatically switched to the standby communication for continuous operation, so that the operation of the Internet of things can be kept smooth to achieve excellent convenience and security for the use of the Internet of things.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An IoT (Internet of Things) system having a standby communication protocol which is implemented in the IoT system, comprising:
at least one IoT control end, including at least one wireless primary communication protocol and at least one wireless standby communication protocol;
at least one IoT device, including at least one wireless primary communication protocol corresponding to the IoT control end and at least one wireless standby communication protocol supporting the IoT device, the wireless standby communication protocol supporting the IoT device being disposed at the IoT control end;
wherein, when in a normal communication state, the IoT control end communicates with the IoT device via the wireless primary communication protocol, when communication between the IoT control end and the IoT device is interrupted, the communication between the IoT control end and the IoT device is switched to the wireless standby communication protocol supporting the IoT device so that the IoT control end and the IoT device whose communication is interrupted can continue to communicate with each other normally.

2. The IoT system as claimed in claim 1, wherein the IoT control end includes a switching module.

3. The IoT system as claimed in claim 2, wherein the switching module is one of a microcontroller and a system on chip (SoC).

4. The IoT system as claimed in claim 1, wherein the wireless primary communication protocol is a LoRa (Long Range) communication protocol.

5. The IoT system as claimed in claim 1, wherein the wireless standby communication protocol is one of TCP/IP, Bluetooth, Zigbee, Wi-Fi 2G, 3G, 4G, RFID, NFC, Z-Wave, and sigfox.

6. The IoT system as claimed in claim 1, wherein the IoT control end is one of a gateway, a router, a switch and a Wi-Fi router.

7. The IoT system as claimed in claim 1, wherein the IoT control end is a mobile device which is one of a mobile phone, a laptop, a tablet, and a personal digital assistant, so that the IoT control end has functions of the mobile device.

8. The IoT system as claimed in claim 2, further comprising an operation process, the operation process comprising the steps of:
step 1: the IoT control end communicating with the at least one IoT device through the wireless primary communication protocol thereof;
step 2: the switching module detecting whether the communication between the IoT control end and the IoT device is normal or not; if yes, going to step 1 to execute operation of the IoT continuously; if no, going to step 3;
step 3: the switching module switching the wireless primary communication protocol of the IoT control end and the corresponding IoT device to the wireless standby communication protocol supporting the IoT device so that the IoT control end communicates with the IoT device through the wireless standby communication protocol; wherein the communication protocol of the corresponding IoT device is also switched to the wireless standby communication protocol thereof.
